(19) United States
(12) Patent Application Publication
(10) Pub. No.: US 2025/0109759 A1
(43) Pub. Date: Apr. 3, 2025

(54) TOGGLE CAM BOLT WITH SELF-ACTUATING TOGGLE SLEEVE

(71) Applicant: Flexicon Corporation, Bethlehem, PA (US)

(72) Inventors: David R. Gill, Easton, PA (US); David McClanahan, Harleysville, PA (US); Daniel Barry, Nazareth, PA (US)

(73) Assignee: Flexicon Corporation, Bethlehem, PA (US)

(21) Appl. No.: 18/479,360

(22) Filed: Oct. 2, 2023

Related U.S. Application Data
(60) Provisional application No. 63/411,757, filed on Sep. 30, 2022.

(51) Int. Cl. F16B 2/18; F16B 13/08

(52) U.S. Cl. CPC F16B 2/18; F16B 13/0808

(57) ABSTRACT

A toggle cam bolt is provided having a threaded shank having a slot at a second end. A cam lever is pivotably attached to the second end. A toggle actuating sleeve in which the shank extends is provided, and includes a collar at one end, a toggle insertion slot and diametrically oppositely located toggle actuating and a toggle clearance slots separated by an actuating web. A toggle is pivotably connected in the shank slot and has a cross arm and an actuator arm. The toggle is movable, from an installation position in which the cross arm is parallel to the bolt axis and the actuator arm extends into the toggle actuating slot, to a clamping position in which a portion of the cross arm extends through the toggle clearance slot due to contact by the actuator arm against the actuating web as the shank is moved in a first direction.

### CROSS-REFERENCE TO RELATED APPLICATIONS

This application claims the benefit of U.S. Provisional Patent Application No. 63/411,757, filed Sep. 30, 2022, which is incorporated herein by reference as if fully set forth.

### BACKGROUND

A cam bolt can be used to fasten or clamp multiple components together. A traditional cam bolt includes a bolt. The bolt is slid through aligned holes in the two or more components that will be joined or clamped together. Once the bolt protrudes through the aligned holes, a fastener, such as a nut, is screwed on to the end of the bolt until tight. Once the fastener is tight, the cam lever is pushed down to further tighten the components together and lock the cam. Initially installing this type of cam bolt requires access to both side of the assembly. Further, tightening the fastener takes time and may require additional tools, such as a wrench. However, close clearances may make using such a tool difficult or impossible.

Toggle cam bolts for blind installations are also known that include a pivotable locking piece that is located in a slot in the bolt shank. After insertion of the bolt shank in a hole, the locking piece can be tipped by gravity, a spring, or contact with the bore hole into a cross-oriented position, and a nut on the exposed end of the bolt shank can then be tightened. However, actuation of the locking piece is not reliable, and removal is very complicated or not possible, making such fasteners not suitable in many applications.

### SUMMARY

A toggle cam bolt is provided having a shank that defines a bolt axis and which includes a first end having a slot and a second end. A cam lever is pivotably attached to the second end of the shank to pivot about a pivot axis that extends normal to the bolt axis, with the cam lever including a lever handle and a cam lobe that is eccentric relative to the pivot axis. The shank extends in a toggle actuating sleeve, and the toggle actuating sleeve includes a sleeve wall, a first end, and a second end. A collar is located at the second end of the sleeve wall. Additionally, the sleeve wall includes a toggle insertion slot and diametrically opposite thereto a toggle actuating slot and a toggle clearance slot separated by an actuating web. A toggle is located in the shank slot and pivotably connected to the shank. The toggle includes a cross arm and an actuator arm, and the toggle is movable, from an installation position in which the cross arm is parallel to the bolt axis and the toggle is generally located within an outer envelope defined by the toggle actuating sleeve with the actuator arm extending into the toggle actuating slot, to a clamping position in which a portion of the cross arm extends through the toggle clearance slot due to contact by the actuator arm against the actuating web as the shank is moved along the bolt axis in a first direction.

In one embodiment, the toggle is pivotably connected to the shank by a pivot pin that extends normal to the bolt axis. To facilitate assembly, a pivot pin access hole is preferably provided in the toggle actuating sleeve through which the pivot pin is inserted for connection of the toggle to the shank.

The toggle is adapted to pivot 90 degrees relative to the shank into the clamping position, but can tilt more or less to align with the underside of the articles being clamped.

In one embodiment, the second end of the shank includes threads, a barrel nut is connected to the threads, and the cam lever is pivotably attached to the barrel nut by at least one pin. In a preferred arrangement, the at least one pin comprises two trunnion pins, and one of the trunnion pins is located on each side of the barrel nut.

A benefit of the present arrangement is that the toggle cam bolt is configured for removable installation by movement of the shank in a direction opposite to the first direction, for example by counter-clockwise rotation of the barrel nut if provided, such that the portion of the cross arm that extends through the toggle clearance slot contacts the actuating web causing the cross arm to pivot back to a position parallel to the bolt axis such that the toggle is generally located within the outer envelope defined by the toggle actuating sleeve and the actuator arm extends into the toggle actuating slot. This allows the toggle cam bolt to be easily installed and removed from one side, making it ideal for blind applications where removability of the articles being connected is necessary for maintenance or other reasons.

In one arrangement, a rubber or synthetic elastomer washer is located under the collar. This helps the toggle actuating sleeve to stay in position and not rotate with the barrel nut during loosening or tightening.

The lever handle can also include a tool insertion recess at a distal end that is adapted to receive a tool.

A method of clamping two or more parts together using a toggle cam bolt is also provided. The method includes: (a) providing a toggle cam bolt as discussed above; (b) inserting the second end of the shank with the toggle actuating sleeve and the toggle in the installation position through an opening in at least two adjacent parts until the toggle is past the opening; (c) moving the toggle, for example by rotating the barrel nut if provided in a first rotation direction, from the installation position to a clamping position in which the actuator arm contacting against the actuating web as the shank is moved along the bolt axis pivots a portion of the cross arm through the toggle clearance slot such that the cross arm extends across the opening into a clamping position; and (d) rotating the lever handle towards the at least two parts until the two parts are clamped, preferably due to a point of contact of the cam lobe and the collar being at or past an over-center position of the cam lobe.

The method can further include, after moving the toggle to the clamping position, further rotating the barrel nut in the first rotation direction to move the cross arm adjacent to an underside of the at least two adjacent parts prior to rotating the cam lever to the over-center position.

The method can further include removing the toggle cam bolt by: (e) rotating the lever handle away from the at least two parts; (f) moving the shank in a direction opposite to the first direction along the bolt axis such that the portion of the cross arm that extends through the toggle clearance slot contacts the actuating web, pivoting the cross arm back to a position parallel to the bolt axis with the toggle generally located within the outer envelope defined by the toggle actuating sleeve and the actuator arm extending into the toggle actuating slot; and (g) withdrawing the second end of the shank with the toggle actuating sleeve and the toggle in the installation position from the opening.

The above-noted features can be used either alone or in various combinations with one another in order to provide the toggle cam bolt in accordance with the invention.

### BRIEF DESCRIPTION OF THE DRAWINGS

The foregoing Summary as well as the following Detailed Description will be readily understood in conjunction with the appended drawings which illustrate preferred embodiments of the invention. In the drawings:

FIG. 1 is a perspective view of a first embodiment of a toggle cam bolt adapted for clamping two or more parts together.

FIG. 2 is an exploded perspective view of the first embodiment of the toggle cam bolt shown in FIG. 1.

FIGS. 3-8 are a series of views showing the first embodiment of the toggle cam bolt of FIGS. 1 and 2 being installed and clamping two or more parts together, illustrating the pivoting of the toggle during installation via the toggle actuating sleeve.

FIGS. 9-13 are a series of views showing a second embodiment of a toggle cam bolt being installed and clamping two or more parts together, illustrating the pivoting of the toggle during installation via the toggle actuating sleeve.

FIG. 14 is a flow chart of a method for clamping two or more parts together using a toggle cam bolt as provided herein.

### DETAILED DESCRIPTION

Certain terminology is used in the following description for convenience only and is not considered limiting. The words “right,” “left,” “top” and “bottom” designate directions in the drawings to which reference is made. This terminology includes the words specifically noted above, derivatives thereof and words of similar import. The term “approximately” means plus or minus 10° for angles, plus or minus normal and customary manufacturing tolerances for any dimensions, and the range encompassed by significant digits for any numbers (i.e., approximately 5 would include 4.6-5.5). The term “generally” means within normal manufacturing tolerances.

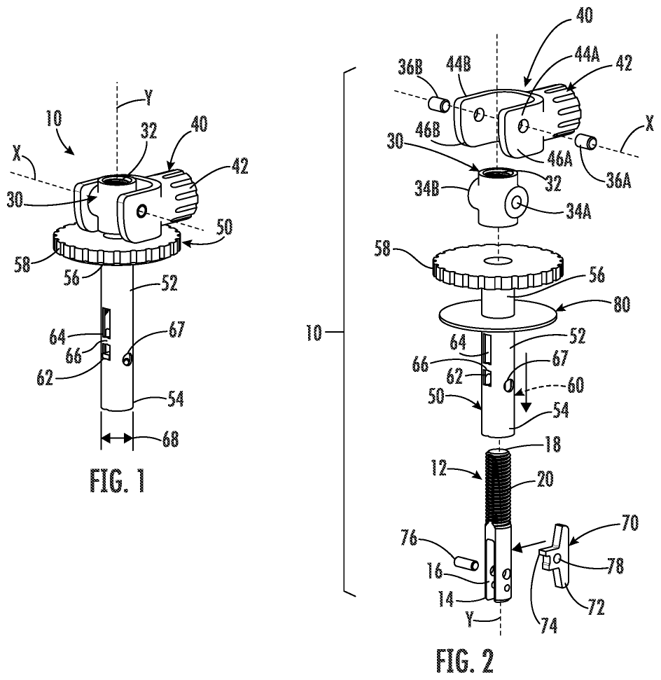

Referring to FIGS. 1, a first embodiment of a toggle cam bolt 10 is shown. The toggle cam bolt 10 is adapted for installation in various applications, such as connecting pipe flanges and/or manifolds in a releasable manner that allows for easy removal for maintenance. It is also particularly useful for blind applications where the opposite side of the opening in which it is inserted is inaccessible.

Referring to FIG. 2, the first embodiment of the toggle cam bolt 10 includes a shank 12 that defines a bolt axis Y and includes a first end 14 having a slot 16 and a second end 18 with threads 20. The shank 12 is preferably made from steel in order to provide sufficient clamping strength and shear strength for various applications. However, other materials could be used depending on the application.

A barrel nut 30 is connected to the threads 20 on the second end 18 on the shank 12. The barrel nut 30 includes internal threads 32 which match the threads 20 of the shank 12 and preferably also includes pivot openings 34A, 34B on opposite sides. The barrel nut 30 is preferably also made of steel. However, other materials could be used depending on the application.

As shown in FIGS. 1 and 2, a cam lever 40 is pivotably attached to the barrel nut 30 to pivot about a pivot axis X that extends normal to the bolt axis Y. The pivot axis X extends through the pivot openings 34A, 34B in the barrel nut. The cam lever 40 includes a lever handle 42 as well as at least one cam lobe 46A, 46B that is eccentric relative to the pivot axis X. Preferably, the lever handle 42 includes two arms 44A, 44B, and an end of each of the arms 44A, 44B is configured with one cam lobe 46A, 46B, respectively. Further, as shown in FIG. 8, the lever handle 42 may include a tool insertion recess 48 at a distal end that is adapted to receive a tool in order to enhance the force that can be applied to the lever handle 42. The tool insertion recess 48 can have various configurations, such as a hexagonal opening or a square opening which is configured to receive the end of the tool being used.

As shown in detail in FIG. 2, the cam lever 40 is pivotably attached to the barrel nut 30 by at least one pin 36A, 36B. Preferably, the at least one pin 36A, 36B comprises two trunnion pins 36A, 36B, and one of the trunnion pins 36A, 36B is located on each side of the barrel nut 30. These pins 36A, 36B extend into the openings 34A, 34B in order to allow pivoting movement between the cam lever 40 on the barrel nut 30.

Still with reference to FIGS. 1 and 2, a toggle actuating sleeve 50 in which the shank 12 extends is provided. The toggle actuating sleeve 50 includes a sleeve wall 52, a first end 54, a second end 56, and a collar 58 located at the second end 56 of the sleeve wall 52. The sleeve wall 52 includes a toggle insertion slot 60 and diametrically opposite thereto a toggle actuating slot 62 and a toggle clearance slot 64 separated by an actuating web 66 formed of the sleeve wall material. The toggle actuating sleeve 50 is preferably a molded or cast part. However, it can also be machined or formed in another manner. It can also be formed of two parts with the sleeve 52 being attached to the collar 58 by various known methods, such as welding, an interference fit, a form locked fit, etc., in a rotationally locked manner so that the collar 58 can be used to hold the toggle actuating sleeve 50 from turning during installation. The toggle insertion slot 60 is best shown in FIGS. 3 and 4 along with the location of the diametrically oppositely located toggle actuating slot 62 and toggle clearance slot 64. These slots 60, 62, 64 are all sized to allow a thickness of the toggle 70, discussed below, to pass through based on a position of the toggle actuating sleeve 50 relative to the shank 12. The sleeve 50 defines an outer envelope 68, indicated in FIG. 1, which in the preferred embodiment is in the form of a cylinder.

Referring now to FIGS. 2 and 3, a toggle 70 is located in the shank slot 16 and is pivotably connected to the shank 12. Preferably, the toggle 70 is pivotably connected to the shank 12 by a pivot pin 76 that extends normal to the bolt axis Y through an opening 78 in the toggle 70. In order to accommodate assembly of the toggle cam bolt 10, a pivot pin access hole 67 is provided in the toggle actuating sleeve 50 through which the pivot pin 76 is inserted for connection of the toggle 72 to shank 12. The pivot pin 76 can be a roll pin or any other suitable type of pin.

The toggle 70 includes a cross arm 72 and an actuator arm 74. The toggle 70 is generally T-shaped with the cross arm 72 forming the top of the T and the actuator arm 74 forming part of the upright. The toggle 70 can be made of steel or another suitable material

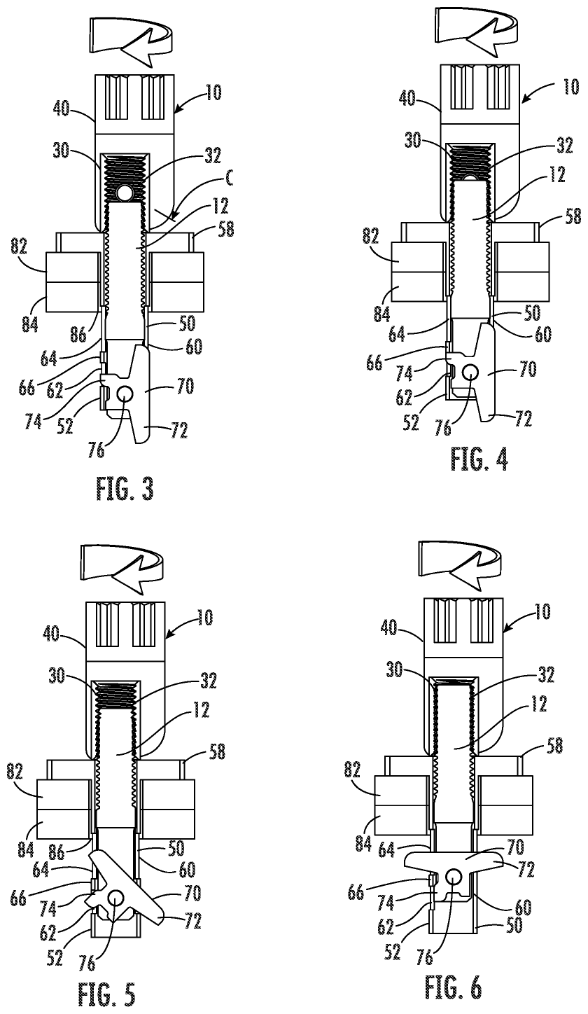

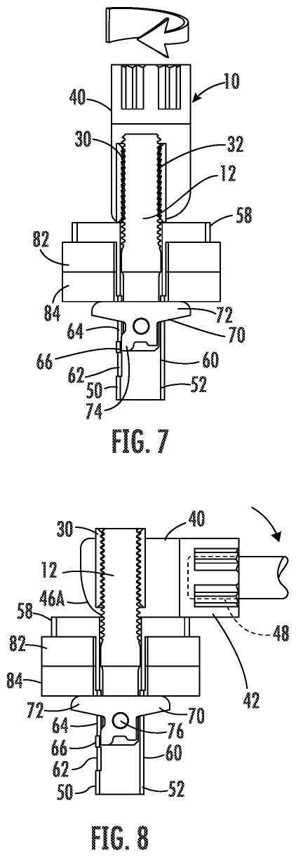

As shown in detail in FIGS. 3-8, the toggle 70 is movable, by rotation of the barrel nut 30 in a first rotation direction, preferably clockwise, from an installation position in which the cross arm 72 is parallel to the bolt axis Y, as shown in FIGS. 3 and 4, and the toggle 70 is generally located within the outer envelope 68 defined by the toggle actuating sleeve 50 with the actuator arm 74 extending into the toggle actuating slot 62, to a clamping position shown in FIGS. 6 and 7, in which a portion of the cross arm 72 extends through the toggle clearance slot 64 due to contact by the actuator arm 74 against the actuating web 66 as the shank is moved in the direction of the bolt axis Y (see FIG. 5) by the barrel nut 30 being rotated, causing a controlled pivoting motion of the toggle 70 about the pivot pin 76.

As shown in FIGS. 3-6, the toggle is adapted to pivot approximately 90° relative to the shank 12 into the clamping position. However, depending upon the configuration of the underside of the parts 82, 84, being clamped, the toggle 70 is capable of pivoting to a matching angle, preferably within +/−10°, while still acting across the opening 86 in the parts being clamped.

As shown in FIG. 2, a rubber or synthetic elastomer washer 80 can be provided under the collar 58. This assists in holding the toggle actuating sleeve 50 via the collar 58 from rotating as the barrel nut 30 is rotated in the first direction for actuating the toggle 70 and clamping.

In a preferred arrangement, the cam lobe 46A, 46B has a center line C, indicated in FIG. 3, of maximum lift from the pivot axis X. In a preferred embodiment, this is 0.060 inches. However, other dimensions could be selected, depending upon the particular application. The cam lever 40 is preferably movable past this center line to an over-center position for clamping.

Based on the configuration of the toggle cam bolt 10, it is uniquely adapted for reversible installation as the toggle 70 is configured to move in a controlled manner back into the envelope 68 of the toggle actuating sleeve 60 by rotating the barrel nut 30 in a direction opposite to the first rotation direction, preferably counter-clockwise, such that a portion of the cross arm 72 that extends through the toggle clearance slot 64 contacts the actuating web 66, causing the cross arm 72 to pivot back to a position parallel to the bolt axis Y as the barrel nut 30 is rotated, with the toggle 70 then being generally located within the outer envelope 68 defined by the toggle actuating sleeve 50 and the actuator arm 74 returning into the toggle actuating slot 62, in a reverse motion shown by FIGS. 6, 5, 4, and 3, consecutively.

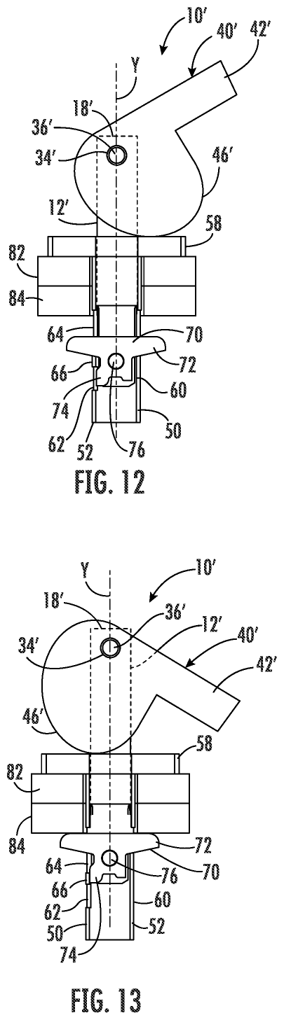

Referring to FIGS. 9-13, a second embodiment of a toggle cam bolt 10′ is shown in an installation sequence similar to FIGS. 3-8. The second embodiment of the toggle cam bolt 10′ is similar to the first embodiment 10, and like elements have the same reference numbers. The toggle actuating sleeve 50 and the toggle 70 are the same as discussed above. However, int eh second embodiment of the toggle cam bolt 10′, the shank 12′ is not threaded. Instead, the shank 12′ has a first end 14′ having the slot 16, as discussed above, and a second end 18′ that includes a pivot opening 34′.

As shown in FIGS. 9-13, a cam lever 40′ is provided and is connected to the second end of the shank 12′ via a pivot pin 36′ that extends through the pivot opening 34′. The cam lever 40′ has a lever handle 42′, which can include a tool insertion recess, such as 48 as discussed above, at a distal end that is adapted to receive a tool in order to enhance the force that can be applied to the lever handle 42′.

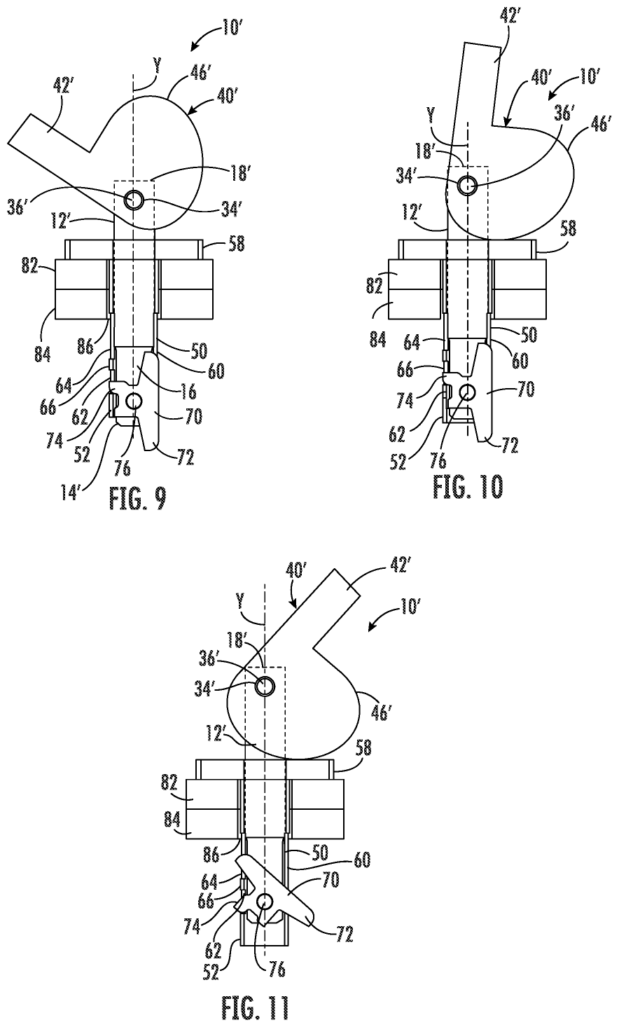

At least one cam lobe 46′ is configured at the end of the lever handle 42′ that has sufficient lift to allow sufficient movement of the shank 12′ in the direction of the Y axis such that after insertion of the toggle actuating sleeve 50 into the openings 86 in the adjacent parts 82, 84 as seen in FIG. 9, rotation of the lever handle 42′ as shown in the progression of FIGS. 10-13 draws the shank 12′ in the Y-axis direction actuating the toggle 70 to rotate due to the actuator arm 74 contacting against the actuating web 66 to pivot a portion of the cross arm 72 through the toggle clearance slot 64 such that the cross arm 72 extends across the opening 86 on the underside of the parts being clamped 82, 84 and into the clamping position, with movement of the cam lever 40′ into an over-center position, as shown in FIG. 13, locking the toggle bolt 10′ in position with a preload force being applied to the parts 82, 84.

While the shank 12′ is shown as one piece, this can be formed as a two piece shank assembly with a shank that is threaded at least partially into a threaded sleeve in order to allow for adjustment to accommodate the total thickness of the parts 82, 84 being clamped. Here, the threaded sleeve would form the second end 18′ with the pivot opening 34′ that connects to the cam lever 40′, and the shank would form the first end 14′ with the slot 16 in which the toggle 70 is mounted. Rotation of the threaded sleeve in one direction or the other would allow the length of the shank assembly to be lengthened or shortened.

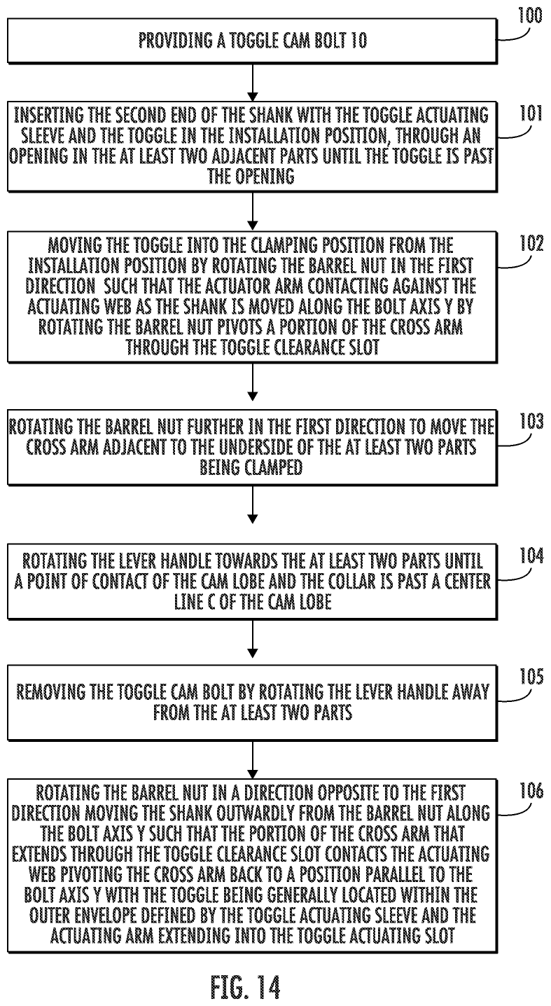

A method of clamping two or more parts 82, 84 together using the first embodiment of the toggle cam bolt 10 is also provided. The method includes providing the first embodiment of the toggle cam bolt 10 as discussed above, as shown at 100 in FIG. 14. In a next step, the first end 14 of the shank 12 is inserted with the toggle actuating sleeve 50 and the toggle 70 in the installation position, shown in FIG. 3, through an opening 86 in the at least two adjacent parts 82, 84, until the toggle 70 is past the opening 86. This is shown at 101 in FIG. 9.

The toggle 70 is then moved into the clamping position from the installation position by rotating the barrel nut 30 in the first rotation direction such that the actuator arm 74 contacting against the actuating web 66 as the shank 12 is moved along the bolt axis Y by the barrel nut 30 pivots a portion of the cross arm 72 through the toggle clearance slot 64 such that the cross arm 72 extends across the opening 86 on the underside of the parts being clamped 82, 84 and into the clamping position. See FIGS. 4-6. This is indicated at 102 in FIG. 9.

At this point, preferably after moving the toggle 70 to the clamping position, the barrel nut 30 is rotated further in the first rotation direction to move the cross arm 72 adjacent to the underside of the at least two parts 82, 84 being clamped as shown in FIG. 7. This is indicated at 103 in FIG. 9.

The lever handle 42 is then rotated towards the at least two parts 82, 84 until a point of contact of the cam lobe 46A, 46B and the collar 58 is past a center line C of the cam lobe 46A, 46B. This is indicated at 104 in FIG. 9.

The method may further include removing the toggle cam bolt 10 by rotating the lever handle 42 away from the at least two parts 82, 84, as shown at 105 in FIG. 9. At that point, the barrel nut 30 is then rotated in a direction opposite to the first rotation direction moving the shank 12 outwardly from the barrel nut 30 along the bolt axis Y such that the portion of the cross arm 72 that extends through the toggle clearance slot 64 contacts the actuating web 66 pivoting the cross arm 72 back to a position parallel to the bolt axis Y with the toggle being generally located within the outer envelope 68 defined by the toggle actuating sleeve 50 and the actuating arm extending into the toggle actuating slot 62. This is shown at 106 in FIG. 9.

At that point, it is then possible to withdraw the second end 18 of the shank 12 with the toggle actuating sleeve 50 and the toggle 70 in the installation position from the opening 86.

A method of clamping two or more parts 82, 84 together using the second embodiment of the toggle cam bolt 10′ is also provided. The method includes providing the second embodiment of the toggle cam bolt 10′ as discussed above. In a next step, the first end 14′ of the shank 12′ is inserted with the toggle actuating sleeve 50 and the toggle 70 in the installation position, shown in FIG. 9, through an opening 86 in the at least two adjacent parts 82, 84, until the toggle 70 is past the opening 86.

The toggle 70 is then moved into the clamping position from the installation position by pivoting the lever arm 42′ of the cam lever 40′ in a first direction such that the actuator arm 74 contacting against the actuating web 66 as the shank 12 is moved along the bolt axis Y by the lifting action of the cam 46′ pivots a portion of the cross arm 72 through the toggle clearance slot 64 such that the cross arm 72 extends across the opening 86 on the underside of the parts being clamped 82, 84 and into the clamping position. See FIGS. 10-12.

Continued rotation of the lever arm 42′ until the cam 46′ travels to an over-center position tightens the toggle cam bolt 10′ with a pre-load to hold the parts 84, 86 together.

It will be appreciated by those skilled in the art that changes can be made to the embodiments of the invention described above without departing from the broad inventive concept thereof. It is also understood that various portions of the invention can be used alone or in combination and that not all of the components are required for any particular application. It is therefore understood that this invention is not limited to the particular embodiments disclosed, but it is intended to cover modifications within the spirit and scope of the present invention.

What is claimed is:

1. A toggle cam bolt comprising:
a shank that defines a bolt axis and includes a first end having a slot and a second end;
a cam lever pivotably attached to the second end of the shank about a pivot axis that extends normal to the bolt axis, the cam lever including a lever handle and a cam lobe that is eccentric relative to the pivot axis;
a toggle actuating sleeve in which the shank extends, the toggle actuating sleeve including a sleeve wall, a first end, and a second end, and a collar located at the second end of the sleeve wall, the sleeve wall including a toggle insertion slot and diametrically opposite thereto a toggle actuating slot and a toggle clearance slot separated by an actuating web; and
a toggle located in the shank slot and pivotably connected to the shank, the toggle including a cross arm and an actuator arm, wherein the toggle is movable, by movement of the shank in a first direction, from an installation position in which the cross arm is parallel to the bolt axis and the toggle is located within an outer envelope defined by the toggle actuating sleeve with the actuator arm extending into the toggle actuating slot, to a clamping position in which a portion of the cross arm extends through the toggle clearance slot due to contact by the actuator arm against the actuating web as the shank is moved along the bolt axis.

2. The toggle cam bolt of claim 1, wherein the toggle is pivotably connected to the shank by a pivot pin that extends normal to the bolt axis.

3. The toggle cam bolt of claim 2, further comprising a pivot pin access hole in the toggle actuating sleeve through which the pivot pin is inserted for connection of the toggle to the shank.

4. The toggle cam bolt of claim 1, wherein the toggle is adapted to pivot approximately 90 degrees relative to the shank into the clamping position.

5. The toggle cam bolt of claim 1, wherein the second end of the shank includes threads, a barrel nut is connected to the threads, and the cam lever is pivotably attached to the barrel nut by at least one pin that extends along the pivot axis.

6. The toggle cam bolt of claim 5, wherein the at least one pin comprises two trunnion pins, and one of the trunnion pins is located on each side of the barrel nut.

7. The toggle cam bolt of claim 1, wherein the toggle is configured for removable installation by movement of the shank along the bolt axis in a direction opposite to the first direction such that the portion of the cross arm that extends through the toggle clearance slot contacts the actuating web causing the cross arm to pivot back to a position parallel to the bolt axis with the toggle located within the outer envelope defined by the toggle actuating sleeve and the actuator arm extending into the toggle actuating slot.

8. The toggle cam bolt of claim 1, further comprising a rubber or synthetic elastomer washer located under the collar.

9. The toggle cam bolt of claim 1, wherein the lever handle includes a tool insertion recess at a distal end that is adapted to receive a tool.

10. A method of clamping two or more parts together using a toggle cam bolt comprising:
providing a toggle cam bolt including a shank that defines a bolt axis and includes a first end having a slot and a second end, a cam lever pivotably attached to the second end of the shank to pivot about a pivot axis that extends normal to the bolt axis, the cam lever including a lever handle and a cam lobe that is eccentric relative to the pivot axis, a toggle actuating sleeve in which the shank extends, the toggle actuating sleeve including a sleeve wall a first end and a second end, and a collar located at the second end of the sleeve wall, the sleeve wall including a toggle insertion slot and diametrically opposite thereto a toggle actuating slot and a toggle clearance slot separated by an actuating web, and a toggle located in the slot and pivotably connected to the shank, the toggle including a cross arm and an actuator arm that, in an installation position, are arranged with the cross arm parallel to the bolt axis and the toggle located within an outer envelope defined by the toggle actuating sleeve with the actuator arm extending into the toggle actuating slot;
inserting the second end of the shank with the toggle actuating sleeve and the toggle in the installation position through an opening in at least two adjacent parts until the toggle is past the opening;
moving the toggle, from the installation position to a clamping position in which the actuator arm contacting against the actuating web as the shank is moved along the bolt axis pivots a portion of the cross arm through the toggle clearance slot such that the cross arm extends across the opening into a clamping position; and
rotating the lever handle towards the at least two parts to clamp the at least two parts together.

11. The method of claim 10, further comprising, providing the second of the shank with threads, connecting a barrel nut to the threads, and connecting the cam lever to the second end of the shank by pivotably connecting the cam lever to the barrel nut, wherein the moving of the shank in a first direction along the bolt axis includes rotating the barrel nut in a first rotation direction, and after moving the toggle to the clamping position, further rotating the barrel nut in the first rotation direction to move the cross arm adjacent to an underside of the at least two adjacent parts.

12. The method of claim 10, further comprising removing the toggle cam bolt by:
rotating the lever handle away from the at least two parts;
moving the shank in a direction opposite to the first direction along the bolt axis such that the portion of the cross arm that extends through the toggle clearance slot contacts the actuating web pivoting the cross arm back to a position parallel to the bolt axis with the toggle located within the outer envelope defined by the toggle actuating sleeve and the actuator arm extending into the toggle actuating slot; and
withdrawing the second end of the shank with the toggle actuating sleeve and the toggle in the installation position from the opening.
